(19) United States
(12) Patent Application Publication
(10) Pub. No.: US 2008/0169114 A1
(43) Pub. Date: Jul. 17, 2008

(54) Power Tool With A Turbine Unit

(76) Inventors: Steffen Wuensch, Holzgerlingen (DE); Steffen Tiede, Herrenberg (DE)

Correspondence Address: MICHAEL J. STRIKER, 103 EAST NECK ROAD, HUNTINGTON, NY, 11743, US

(21) Appl. No.: 11/909,363

(22) PCT Filed: Nov. 16, 2006
(86) PCT No.: PCT/EP2006/068573

§ 371 Date: Sep. 21, 2007

(30) Foreign Application Priority Data
Dec. 29, 2005 (DE) 102005062887.7

(51) Int. Cl. B25F 5/00; B23D 47/12; B23B 45/04; F16H 21/00

(52) U.S. Cl. 173/198; 74/25; 74/86; 74/665 GB; 173/218

(57) ABSTRACT

A portable power tool having a turbine unit (10a, 10b) is proposed, which is intended to be driven by a suction air flow (12a; 12b), and having a gearing unit (14a; 14b; 14c) via which the turbine unit (10a, 10b) is coupled to an output unit (16a; 16b; 16c).

### PRIOR ART

Power tools are already known that have a turbine unit which is intended to be driven via a flow of compressed air from a compressed air connection.

### ADVANTAGES OF THE INVENTION

A power tool with a turbine unit is proposed which is intended to be driven by a flow of suction, and having a gear unit way of which the turbine unit is coupled to a power takeoff unit. The term “turbine unit that is intended to be driven by a flow of suction” should be understood in particular to mean a unit which, upstream of a turbine in the flow direction, has intake means, such as intake openings and intake conduits in particular, and downstream of the turbine in the flow direction in particular has a coupling point with a drive unit that generates a flow of suction. The term “intended” should be understood in particular to mean equipped and/or designed. By means of an appropriate embodiment according to the invention, advantageous supplementary functions can be made possible by the flow of suction, for instance in particular chip extraction by suction, and by means of the gear unit, advantageous fixed, nonadjustable or adjustable motion conversions and/or step-up actions—and associated with this, in particular, advantageous torques—can be assured, as a result of which a drilling, milling, screwing, sanding, scraping, and/or sawing mode, in particular, can advantageously be made possible, and the power tool can be embodied as a power drill, power milling cutter, power saw, power sander, scraper, and/or screwdriver, and so forth.

In principle, the gear unit may be designed with or without a step-down action. If the gear unit is intended for converting a rotary motion into a pendulum motion or an oscillating motion, then operation that is advantageously risk-free, particularly in power drills, can be attained, and a sawing motion in power saws can be made possible in a structurally simple way. Moreover, a reduced dust burden can be attained. A corresponding gear unit can be structurally attained with an eccentric unit.

In a further feature of the invention, it is proposed that the gear unit includes an angular gear, as a result of which an advantageously flexible integration of the gear unit can be made possible. Alternatively or in addition, the gear unit could also have a spur gear, a planetary gear, and so forth.

It is also proposed that the gear unit is embodied at least partially integrally with a tool receptacle unit, as a result of which additional components, installation space, weight, complex assembly, and expenses can be saved.

If the turbine unit includes a Pelton turbine, then especially high efficiency can be attained.

The power tool preferably has at least one conduit that is intended for chip extraction by suction; as a result, additional units for chip extraction by suction can at least largely be avoided, and compact chip extraction by suction with only a few additional components and with high efficiency can be attained, especially if the conduit opens out on a face end oriented toward a tool receptacle region.

It is also proposed that the conduit is embodied at least partially integrally with a supply conduit or an intake conduit of the turbine unit, as a result of which again components, installation space, weight, and complicated assembly can be economized on.

If the power tool has a connection means which is intended to be connected to an external suction unit, such as an external vacuum cleaner, then high suction power can simultaneously be made possible in a very lightweight power tool, especially if the power tool can advantageously be embodied without its own electric motor. Moreover, safety precautions required by an electric motor can at least be reduced, such as protection against moisture, protection against dust, and so forth.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a first schematically illustrated power tool, embodied as a power saw, with a sawing tool;

FIG. 2, a second schematically illustrated power tool, embodied as a power drill, with a drilling tool;

FIG. 3, individual parts of an alternative power tool; and

FIG. 4, a longitudinal section through the individual parts of FIG. 3.

### DESCRIPTION OF THE EXEMPLARY EMBODIMENTS

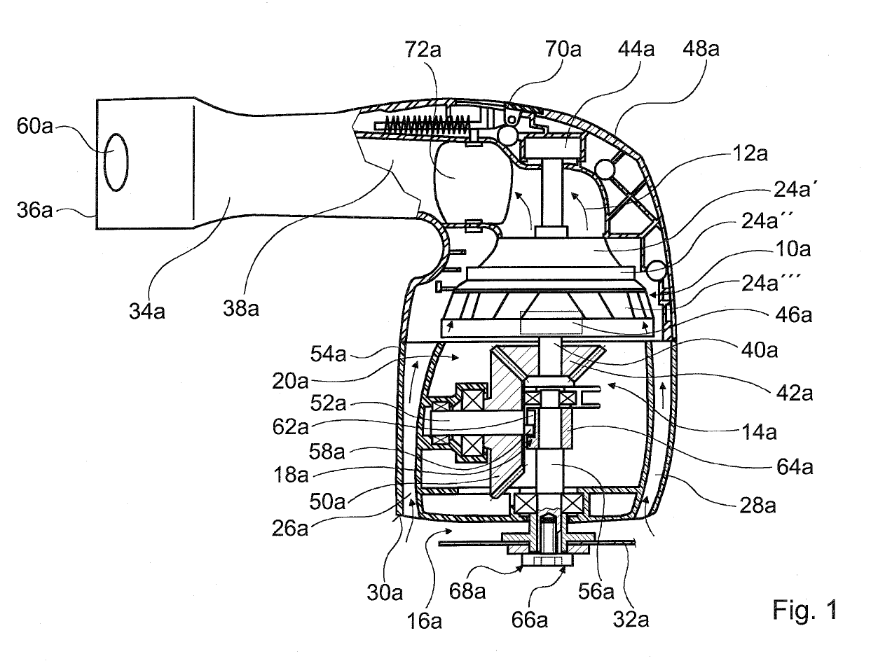

FIG. 1 shows a schematically illustrated power saw, designed in an L shape, for driving a sawing tool 32a. The power saw has a turbine unit 10A with a substantially triangularly embodied Pelton turbine 24a′, 24a′, 24a′″, which is intended to be driven by a flow of suction 12a. The Pelton turbine 24a′, 24a″, 24a′″ has two individual fans and an air guide disk. The Pelton turbine 24a′, 24a″, 24a′″ is supported via a turbine shaft 40a and ball bearings 44a, 46a in a housing 48a of the power tool. The power tool has a handle 34a, formed by a tubular component and formed integrally onto the housing 48a, that on its free end has a connection means 36a, formed by a connection point, with a locking unit 60a for a hose of a mobile external vacuum cleaner, not shown, or external suction unit and that forms a conduit 38a of the turbine unit 10A. By means of the vacuum cleaner, the requisite flow of suction 12a can be generated. The handle 34a extends along a first leg, and the turbine shaft 40a extends along a second leg, of the L-shaped power saw.

The power saw furthermore has a gear unit 14a, by way of which the turbine unit 10A is coupled to a power takeoff unit 16a. The gear unit 14a is intended for converting a rotary motion of the Pelton turbine 24a′, 24a″, 24a′″ into a pendulum motion, or into a reciprocating motion. A pinion 42a of an angular gear 20a of the gear unit 14a is press-fitted onto the turbine shaft 40a of the Pelton turbine 24a′, 24a″, 24a′″ and meshes with a plate wheel 50a of the angular gear 20a. The angular gear 20a serves as a step-down gear; that is, it serves to reduce a rotary turbine speed of the angular gear 20a and to increase an available torque, and it has a gear ratio of approximately i=2. The plate wheel 50a is press-fitted onto a gearshaft 52a that is supported in a gearbox 54a and is perpendicular to the turbine shaft 40a, and the end of this gearshaft has an eccentric peg 58a of an eccentric unit 18a of the gear unit 14a formed integrally onto it that is oriented toward a power takeoff shaft 56a that is likewise supported in the gearbox 54a and is oriented coaxially to the turbine shaft 40a. The eccentric peg 58a engages a longitudinal groove 62a, extending in the axial direction of the power takeoff shaft 56a, of a sleeve 64a that is press-fitted onto the power takeoff shaft 56a and is formed by a sintered component. To attain the most linear possible contact area between the eccentric peg 58a and the sleeve 64a, the eccentric peg 58a is embodied in bulging or barrel-shaped form; that is, its rolling radius is adapted to its engagement line in the longitudinal groove 62a.

On a free end, protruding from the gearbox 54a, of the power takeoff shaft 56a, a tool receptacle unit 68a is secured, which is intended to receive the sawing tool 32a by means of a screw connection 66a.

The gearbox 54a is embodied as essentially double-walled, and between its walls it forms conduits 26a, 28a, which are intended as supply conduits of the turbine unit 10a and for chip extraction by suction. The conduits 26a, 28a open out at a face end 30a oriented toward a tool receptacle region.

When the vacuum cleaner has been activated, a flap 72a, pivotably supported in the conduit 38a, can be actuated by the user by means of a switch 70a located on the handle 34a; specifically, by means of the flap 72a, the conduit 38a can be opened in order to activate the turbine unit 10a, and the conduit 38a can be closed in order to deactivate the turbine unit 10a.

If the conduit 38a is opened by means of the flap, the turbine unit 10A is driven via a flow of suction 12a that ensues. The rotary motion of the Pelton turbine 24a′, 24a″, 24a′″ is transmitted via the angular gear 20a to the gearshaft 52a and to the eccentric peg 58a, by way of which the rotary motion is transmitted into a pendulum motion of the sleeve 64a and the power takeoff shaft 56a. The power takeoff shaft 56a transmits the pendulum motion to the sawing tool 32a via the tool receptacle unit 68a. Chips produced operation are aspirated into the vacuum cleaner through the conduit 38a via the conduits 26a, 28a through the Pelton turbine 24a′, 24a″, 24a′″.

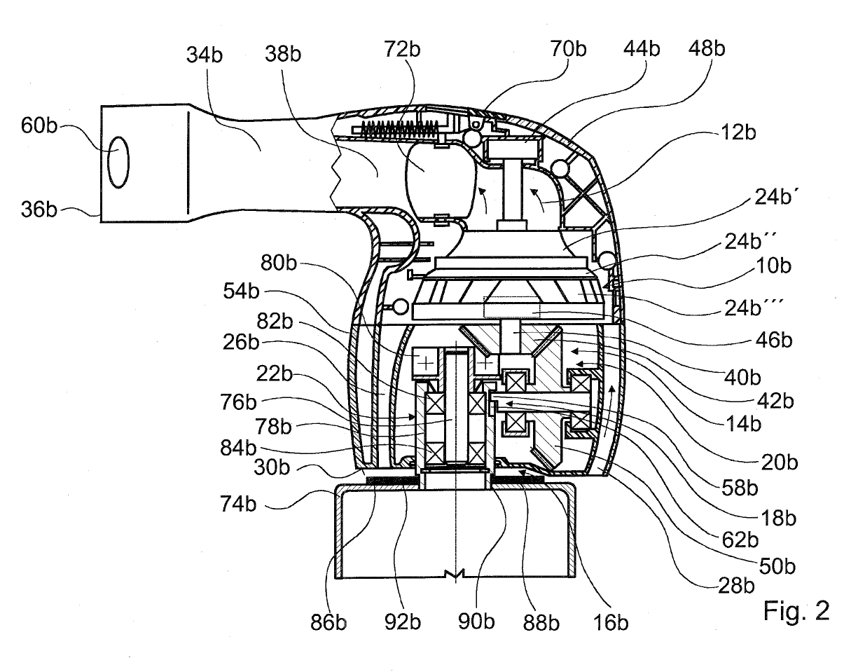

In FIGS. 2 through 4, alternative exemplary embodiments are shown. Components, characteristics and functions that remain substantially the same are all identified by the same reference numerals as before. To distinguish among the exemplary embodiments, however, the letters a, b and c are added to the reference numerals in the various exemplary embodiments. The ensuing description will be limited essentially to the differences from the exemplary embodiment of FIG. 1; with regard to components, characteristics and functions that remain the same, reference may be made to the description of the exemplary embodiment in FIG. 1.

FIG. 2 shows a schematically illustrated L-shaped power drill for driving a compass saw or a drilling tool 74b. The power drill has a turbine unit 10B with a Pelton turbine 24b′, 24b″, 24b′″, which is intended to be driven by a flow of suction 12b.

The power tool furthermore has a gear unit 14b, by way of which the turbine unit 10B is coupled to a power takeoff unit 16b. An eccentric peg 58b is integrally formed onto an end, oriented toward a bearing shaft 76b oriented axially parallel to a turbine shaft 40a, of a gearshaft 52b of an angular gear 20b of the gear unit 14b. The bearing shaft 76b is supported in a gearbox 54b via a flange 80b. The eccentric peg 58b engages a longitudinal groove 62b, extending in the axial direction of the bearing shaft 76b, of a sleeve 78b that is rotatably supported on the bearing shaft 76b via two roller bearings 82b, 84b. The sleeve 78b forms a part of a tool receptacle unit 22b.

On a free end of the sleeve 78b that protrudes from the gearbox 54b, an annular-disklike flange 86b is secured, on the side of which remote from the gearbox 54b, a hook-and-loop closure layer 88b is applied. The essentially cup-shaped drilling tool 74b has a recess 90b in its bottom part, and with this recess the drilling tool 74b is placed on the sleeve 78b. The drilling tool 74b is centered via the sleeve 78b. On a side oriented toward the gearbox 54b, the drilling tool 74b has a hook-and-loop closure layer 92b, which is intended for correspondence with the hook-and-loop closure layer 88b and is coupled to it. Via the hook-and-loop closure layers 88b, 92b, during operation, the drilling tool 74b is secured in the axial direction, while for transmitting a torque to the drilling tool 74b, the sleeve 78b and the drilling tool 74b are coupled in the circumferential direction via a form-locking connection, not shown in further detail, that is formed by integrally formed-on flat faces and extensions.

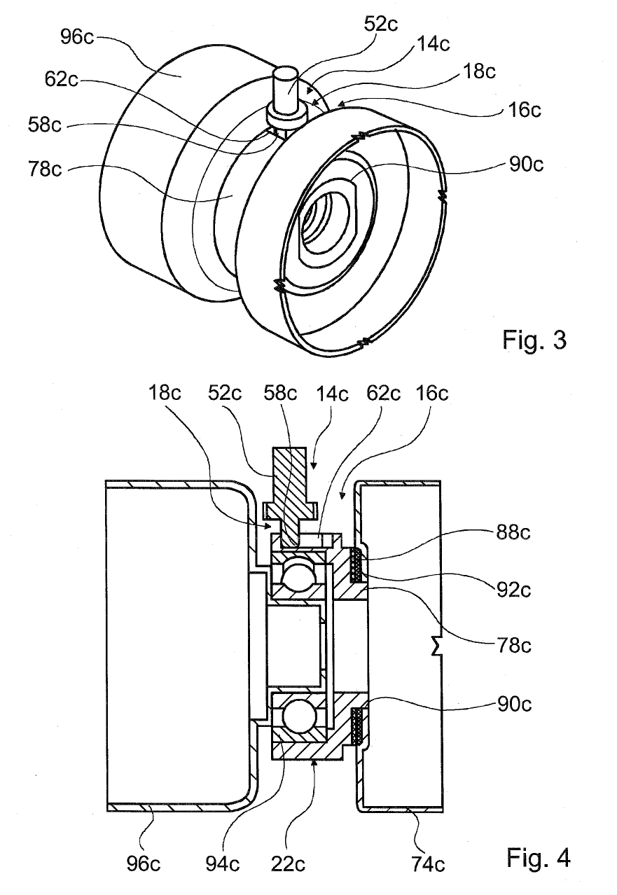

In FIGS. 3 and 4, individual parts of a further, alternative power drill corresponding essentially to the power drill in FIG. 2, are shown, in particular a gear unit 14c and a power takeoff unit 16c. The gear unit 14c includes an eccentric unit 18c, with an eccentric peg 58c that is integrally formed onto a rotationally drivable gearshaft 52c.

The eccentric peg 58c engages a longitudinal groove 62c, extending in the axial direction of a drilling tool 74c, of a sleeve 78c of graduated embodiment. The sleeve 78c is supported via a roller bearing 94c on a housing part 96c of the power drill.

1. A power tool having a turbine unit (10a; 10b) which is intended to be driven by a flow of suction (12a; 12b), and having a gear unit (14a; 14b; 14c), by way of which the turbine unit (10a; 10b) is coupled to a power takeoff unit (16a; 16b; 16c).

2. The power tool as defined by claim 1,
characterized in that
the gear unit (14a; 14b; 14c) is intended for converting a rotary motion into a pendulum motion.

3. The power tool as defined by claim 2,
characterized in that
the gear unit (14a; 14b; 14c) includes an eccentric unit (18a; 18b; 18c).

4. The power tool as defined by claim 1,
characterized in that
the gear unit (14a; 14b; 14c) includes an angular gear (20a; 20b).

5. The power tool as defined by claim 4,
characterized in that
the gear unit (14b; 14c) is embodied at least in part integrally with a tool receptacle unit (22b; 22c).

6. The power tool as defined by claim 1,
characterized in that
the turbine unit (10a; 10b) includes a Pelton turbine (24a; 24b).

7. The power tool as defined by claim 1,
characterized by
at least one conduit (26a, 28a; 26b, 28b), which is intended for chip extraction by suction.

8. The power tool as defined by claim 7,
characterized in that
the conduit (26a, 28a; 26b, 28b) opens out on a face end (30a; 30b) oriented toward a tool receptacle region.

9. The power tool as defined by claim 7,
characterized in that
the conduit (26a, 28a; 26b, 28b) is embodied at least partially integrally with a supply conduit of the turbine unit (10a; 10b).

10. The power tool as defined by claim 1,
characterized by
a connection means (36a; 36b), which is intended for being connected to an external suction unit.
